(19) United States
(12) Patent Application Publication
(10) Pub. No.: US 2018/0082605 A1
(43) Pub. Date: Mar. 22, 2018

(54) Hypobaric System and Apparatus

(71) Applicants: Will Kohnen, Claremont, CA (US); Midland Development Corporation, Midland, TX (US)

(72) Inventors: Livingston Holder, Issaquah, WA (US); LaVerne Bjerke, Woodinville, WA (US); Marti Sarigul Klijn, Dixon, CA (US); Ken Doyle, Midland, TX (US); Will Kohnen, Claremont, CA (US)

(21) Appl. No.: 15/705,941

(22) Filed: Sep. 15, 2017

Related U.S. Application Data
(60) Provisional application No. 62/395,486, filed on Sep. 16, 2016.

(51) Int. Cl. G09B 9/00; G09B 19/00

(52) U.S. Cl. CPC G09B 9/00; G09B 19/00

(57) ABSTRACT

A ground-based system and apparatus useful for simulating a high altitude hypobaric environment, the system including a plurality of hypobaric test chambers of different sizes that can be quickly and efficiently evacuated by means of a depressurization apparatus further comprising a plurality of operatively connected vacuum tanks to produce, selectively adjust and sustainably control the hypobaric environment for a desired interval ranging from minutes to weeks. The subject test chambers each have at least one large viewing port providing clear interior visibility to an external observer and desirably also include apparatus for conveniently maneuvering payloads into and out of the test chambers.

### 1. FIELD OF THE INVENTION

This invention relates to ground-based hypobaric chamber systems and apparatus configured to rapidly depressurize or decompress a contained volume of air sufficiently to reach atmospheric pressures comparable to those encountered at altitudes ranging from about 60,000 to about 100,000 feet above sea level in about 5 to 15 seconds, and to sustain such pressure levels throughout a desired operational period. Another aspect of the invention relates to hypobaric chamber installations configured to restore air pressure inside a previously depressurized hypobaric chamber to a level equivalent to that of about sea level. Facilities comprising a plurality of differently configured and sized hypobaric chambers providing exceptional visibility and unique logistical capabilities are also disclosed. Such logistical capabilities include, for example, hoists and cargo handling devices configured to support and reposition equipment and devices to be used or tested inside the subject chambers.

### 2. DESCRIPTION OF RELATED ART

Conventional hypobaric chambers, sometimes referred to as altitude chambers, are typically small enclosures with reinforced walls and doors, and small viewing windows, and are configured to subject one or two individuals to low-pressure atmospheric conditions for various test purposes, such as assessing and evaluating the human response to conditions of hypoxia or hypobaria. One such chamber is known to exist at Edwards AFB. It is believed to have room for only one occupant, and an observer must stand outside the chamber, close to a rectangular window for a partial view of the occupant. Some conventional hypobaric chambers utilize “glove boxes” that enable a user to perform functions inside a hypobaric chamber, again while standing outside the chamber. Other known multi-person chambers can only support personnel in flight suits with oxygen masks and may be limited, for example, to an altitude equivalent of about 20,000 feet.

Larger chambers are needed, however, that are configured especially for equipment evaluation, personnel training, and the like. Such chambers should desirably facilitate hypobaric testing of larger groups of people or more products and equipment, provide greater visibility of and for the subjects being tested or observed, provide a selection of test chamber sizes and configuration, provide improved systems for loading and unloading the chambers, and provide the capability for reaching test pressures corresponding to higher altitudes more rapidly, efficiently and economically. Such a system and apparatus are disclosed here.

### SUMMARY OF THE INVENTION

A ground-based hypobaric testing system and apparatus are disclosed here that desirably comprise a plurality of test chambers of different sizes and configurations. The subject hypobaric chambers are useful for various purposes and can be configured, for example, for testing products, such as flight suits, equipment and instruments. Other hypobaric chambers can be configured for use in training personnel, larger groups of equipment. The hypobaric chambers of the invention are also desirably equipped to provide greater visibility of and for the subjects being tested or observed. Improved systems for loading and unloading the chambers are also disclosed. Significantly, the systems of the invention desirably embody a capability for reaching test pressures corresponding to higher altitudes more rapidly, efficiently and economically than the conventional, commercially available systems and apparatus.

Although the time required to reach a desired target pressure can vary in accordance with the chamber size and the ancillary equipment, typical depressurization times ranging from about 5 to about 15 seconds are achievable through use of the present invention. Such installations are desirably configured to house as few as two or as many as ten persons in a simulated flight deck or cabin, and are beneficial for use in testing space suits and equipment prior to space operations. The hypobaric systems of the invention provide users the opportunity to become familiar with wearing pressurized suits, perform tasks in a high altitude environment, and train under conditions of hypoxia. The subject installations also desirably provide excellent visibility both to occupants and external observers.

In one embodiment the system and apparatus disclosed here include at least three hypobaric chambers for testing equipment and for training personnel in normal and emergency flight conditions. The system includes at least one, and preferably a plurality of, Equipment Chambers for testing compact equipment and instruments; at least one, and preferably a plurality of, two-person Suit Chambers for testing pressure suits and the like; and at least one, and preferably a plurality of, Cabin Chambers accommodating up to 10 or more persons in a simulated flight deck or cabin. The hypobaric system of the invention is intended to be a highly reliable and efficient human-rated, commercial altitude chamber testing facility capable of testing both personnel and equipment in vacuum. The Equipment Chamber and Suit Chamber will support testing of space suits and equipment prior to operations in space. They will also provide valuable experience for flight personnel to become familiar with wearing pressurized spacesuits and performing tasks in a high altitude environment. The Cabin Chamber will allow simultaneous group testing and evaluation of several, preferably up to ten or more, occupants in a single simulated cabin environment.

In one embodiment of the system and apparatus of the invention, in order to achieve high altitude conditions rapidly, the chambers of the subject system are desirably operatively connected to at least one, and preferably two or more, vacuum tanks having interior volumes sufficiently greater than the interior volumes of the hypobaric test chambers. When the vacuum tanks are configured in this manner and substantially evacuated, they can rapidly draw air out of one or more of the test chambers. For example, a small, two-person Suit Chamber can rapidly depressurize from sea-level to a simulated 100,000-foot altitude environment in less than five seconds. A larger, 10-person cabin chamber can depressurize from sea level to a simulated 60,000-foot altitude in less than 15 seconds. One significant difference between the present system and other hypobaric chamber installations is the capability to run more than one chamber concurrently.

The test chambers of the invention desirably comprise at least one large-diameter acrylic dome or cylinder to provide greater visibility to both occupants and observers than are commonly encountered in hypobaric chambers. The equipment chamber is, for example, desirably equipped with a hoist that can lift the dome and equipment to be tested, and a support stand that can be used in conjunction with the hoist to adjust the base height of the chamber. If desired, lockable wheels and a tip-resistant base can also be provided as part of the support stand. An electronic control and valve assembly satisfactorily allow the chamber to fly user-specified altitude profiles over extended periods such as weeks or months.

The cabin chamber can provide rapid decompression from sea level to about 60,000 feet as rapidly as 15 seconds or less, can accommodate ten persons in space suits simultaneously and can then “ascend” to an altitude equivalent of 100,000 feet or greater if desired. The cabin chamber desirably comprises cylindrical acrylic wall sections and a full-diameter, domed hemispherical door to provide enhanced visibility. Additionally, the cabin chamber desirably has a unique rail and carriage system that permits users to install and remove full-length equipment sets rapidly. With this capability, users can build up test equipment in an unconstrained manner outside the chamber, and then quickly and easily roll it into the chamber for testing or for use in other operations.

Other advantages and benefits of the system and apparatus of the invention will be appreciated upon reading the full disclosure in relation to the appended drawing figures.

### BRIEF DESCRIPTION OF THE DRAWINGS

The apparatus of the invention is further described and explained in relation to the following drawings wherein:

FIG. 1 is a simplified diagrammatic view of one embodiment of the hypobaric system and apparatus of the invention;

FIG. 2 is a simplified diagrammatic view depicting in greater detail the vacuum system used to depressurize a Suit Chamber and a Cabin Chamber of one embodiment of the invention;

FIG. 3 is a top perspective view of one embodiment of an Equipment Chamber, including a hoist, satisfactory for use in the invention;

FIG. 4 is a top perspective view, partially broken away, of one embodiment of a Glove Box Chamber satisfactory for use in the invention;

FIG. 5 is a front perspective view of one embodiment of a Suit Chamber satisfactory for use in the invention; shown with the door closed;

FIG. 6 is a front perspective view of the Suit Chamber of FIG. 5, shown with the door open;

FIG. 7 is a rear perspective view of the Suit Chamber of FIG. 6;

FIG. 8 is a rear elevation view, partially in section, of one embodiment of a Suit Chamber satisfactory for use in the invention;

FIG. 9 is a side elevation view, partially in section, of the Suit Chamber of FIG. 8;

FIG. 10 is a front perspective view, of one embodiment of a Cabin Chamber satisfactory for use in the invention;

FIG. 11 is a side elevation view of the Cabin Chamber of FIG. 10;

FIG. 12 is a side perspective view of the Cabin Chambers of FIGS. 10-11, shown with the front and rear doors open;

FIG. 13 is a side-front perspective view of another embodiment of a Cabin Chamber satisfactory for use in the invention, showing a rail and carriage subassembly disposed inside the Cabin Chamber;

FIG. 14 is a detail front perspective view of the rail and carriage subassembly as shown in FIG. 13;

FIG. 15 is a simplified, diagrammatic, front elevation view of a Cabin Chamber of the invention, showing both the front and rear doors open and a capsule disposed inside the Cabin Chamber; and

FIG. 16 is a simplified diagrammatic view of another embodiment of a vacuum system suitable for use as part of the system and apparatus of the invention.

It should be appreciated in reading this disclosure in relation to the appended drawings that the Figures are diagrammatic, are not drawn to scale, and that relative sizes, dimensions and proportions may be but are not necessarily as shown.

### DESCRIPTION OF THE PREFERRED EMBODIMENTS

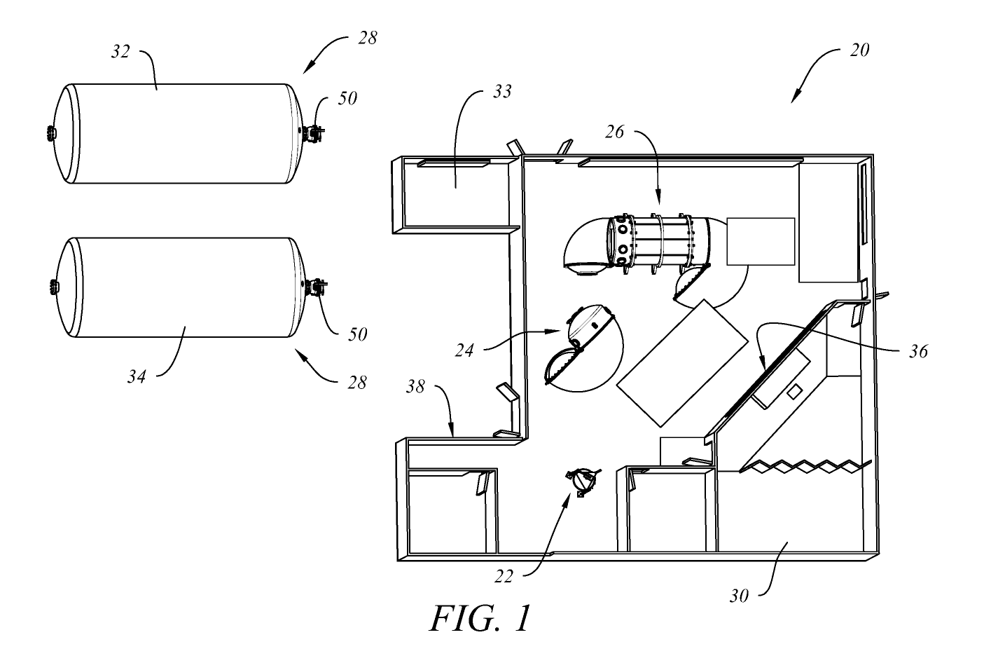

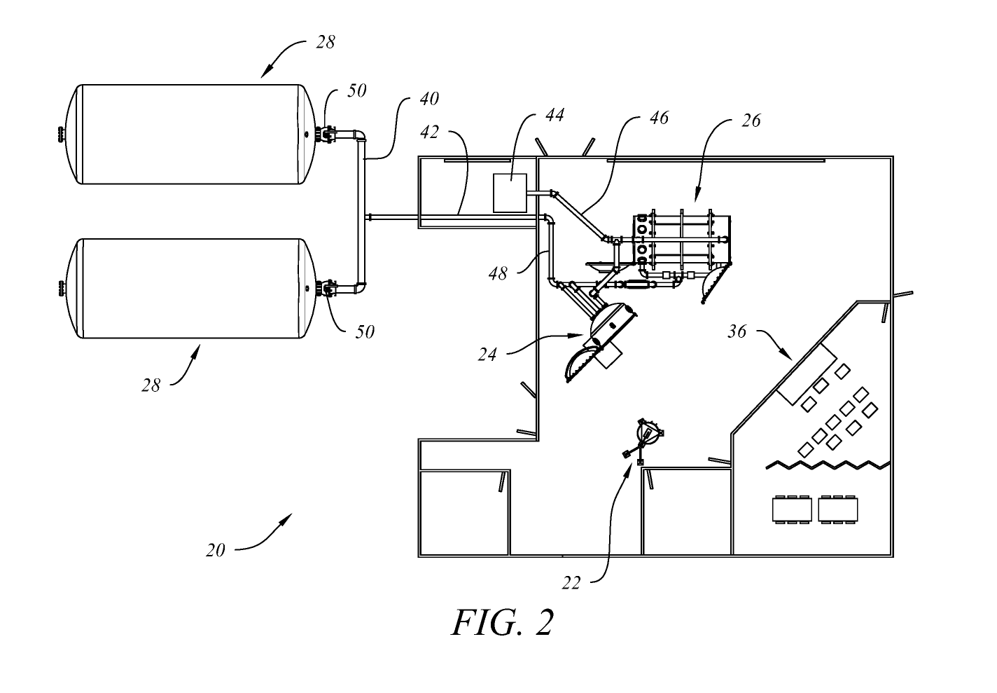

Referring to FIG. 1, hypobaric system and apparatus 20 desirably comprises facility 38 further comprising a plurality of hypobaric test chambers as represented, for example, by Equipment Chamber 22, Suit Chamber 24, and Cabin Chamber 26. Control panel 36 and training area 30 are optionally provided in or near facility 38 for use in performing tasks and for training personnel associated with implementing the testing, training, and other objectives for hypobaric system and apparatus 20. Vacuum system 28 comprising vacuum tanks 32, 34 is desirably provided either inside or adjacent to facility 38. Each of vacuum tanks 32, 34 further comprises valves 50 by which tanks 32, 34 are placed in fluid communication with apparatus disposed in Vacuum Pump Room 33 of facility 38. Referring to FIG. 2, lines 40, 42 are shown communicating with valves 50 and with line 48 connected to test chambers 24, 26. Lines 40, 42, 48 are desirably relatively large-diameter lines adapted for use in rapidly evacuating Equipment Chamber 24 and/or Cabin Chamber 26. Lines 46 in FIG. 2 connect test chambers 24, 26 to a smaller vacuum pump 44 optionally provided for use in making finer adjustments to the air pressure inside the chambers during testing.

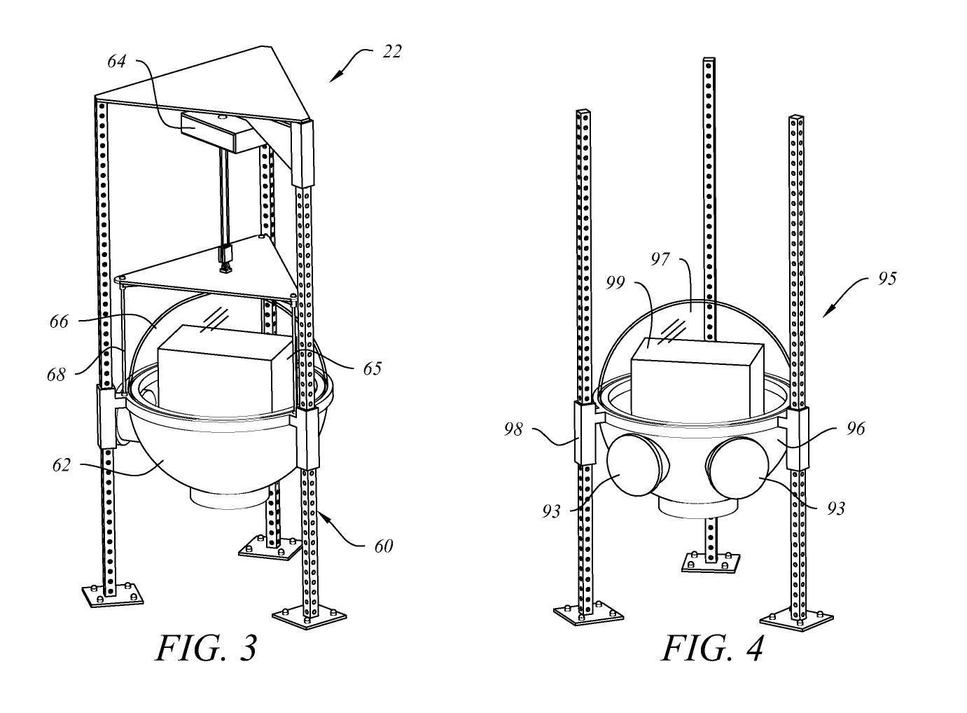

Referring to FIG. 3, Equipment Chamber 22 further comprises body 62 and selectively removable cover 66. Body 62 is desirably supported at selectively adjustable heights by support stand 60, and can be raised or lowered as needed by hoist 64 and support rods 68. Alternatively, hoist 64 can be selectively used to open transparent cover 66 relative to body 62, to access Equipment 65 disposed inside Equipment chamber 22 for testing. Flow lines connecting Equipment Chamber 22 to vacuum system 28 (FIG. 2) are not shown in FIG. 3.

Referring to FIG. 4, Glove box 95 is optionally provided in facility 38 (FIG. 1) and is also connected to vacuum system 28 (FIG. 2). Glove box 95 desirably comprises body 96 and transparent cover 97. Body 96 is adjustably mounted on stand 98 and cooperates with transparent cover 97 to form an enclosed, airtight chamber containing equipment 99 that can be manipulated by a user standing beside airtight glove ports 93.

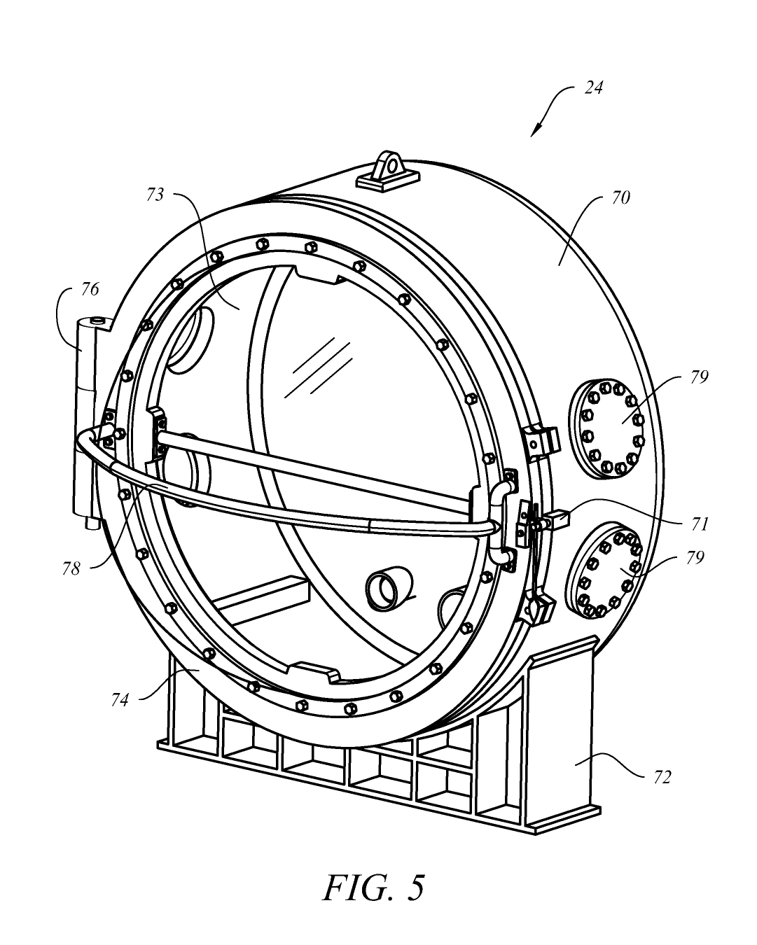

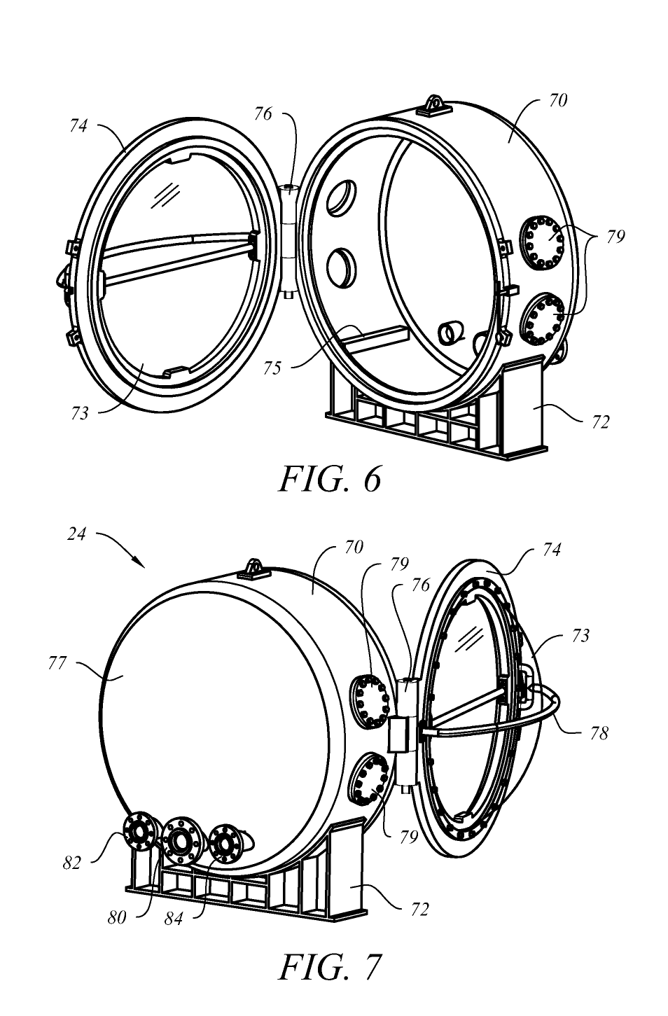

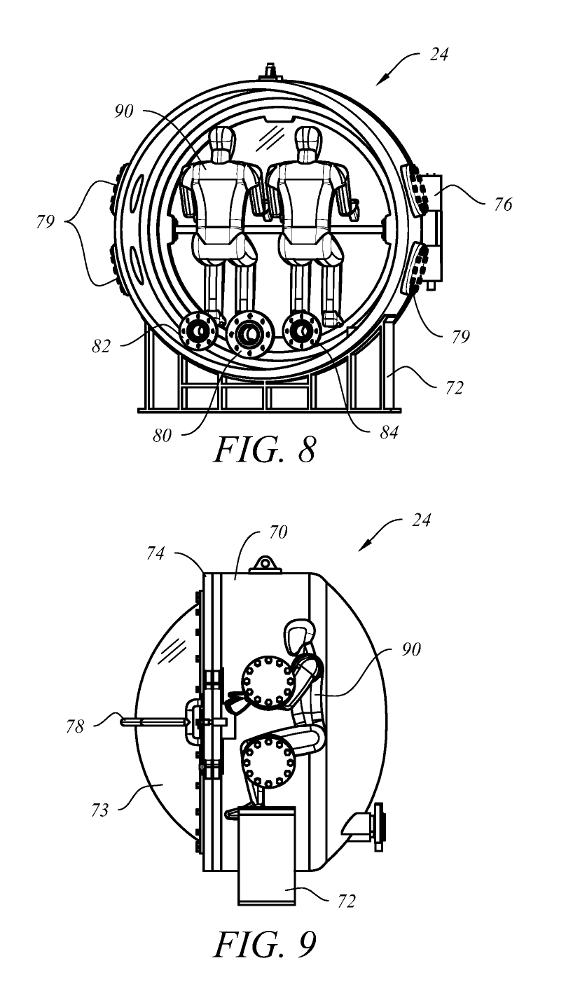

Referring to FIGS. 5-9, Suit Chamber 24 is another hypobaric test chamber disposed inside facility 38 (FIG. 1). In a preferred embodiment, Suit Chamber 24 is configured for testing the performance of pressurized suits worn by individuals training for suborbital space flights. Suit chamber 24 is configured to be an airtight enclosure that can be depressurized rapidly and repeatedly to an internal pressure level corresponding, for example, to the air pressure experienced at an altitude ranging between about 60,000 and about 100,000 feet. Suit Chamber 24 desirably comprises a cylindrical body 70 having a back wall 77 and a front door 74 attached to cylindrical body 70 by hinge 76. Cylindrical body 70 is supported by stand 72. Front door 74 further comprises a steel frame supporting a substantially full-diameter, hemispherical, transparent observation dome 73, preferably made of an acrylic resin or other similarly effective material, and handle 78. Door 74 is selectively moveable into abutting engagement with circumferentially extending annular seal 75 (FIG. 6) and is releasably secured by latch 71. In the embodiment shown, viewing ports 79 are also provided through the wall of cylindrical body 70 to facilitate observation of all areas inside the chamber. Referring to FIGS. 7 and 8, fluid conduits 80, 82, 84 and their associated flanges are provided for use in establishing fluid communication between the interior of Suit Chamber 24, vacuum system 28 (FIG. 2), and the air return lines of the invention. Referring especially to FIGS. 8-9, two occupants in pressurized suits 90 are depicted diagrammatically inside Suit Chamber 24 of the invention, such as for the purposes of pressurized suit testing or personnel training.

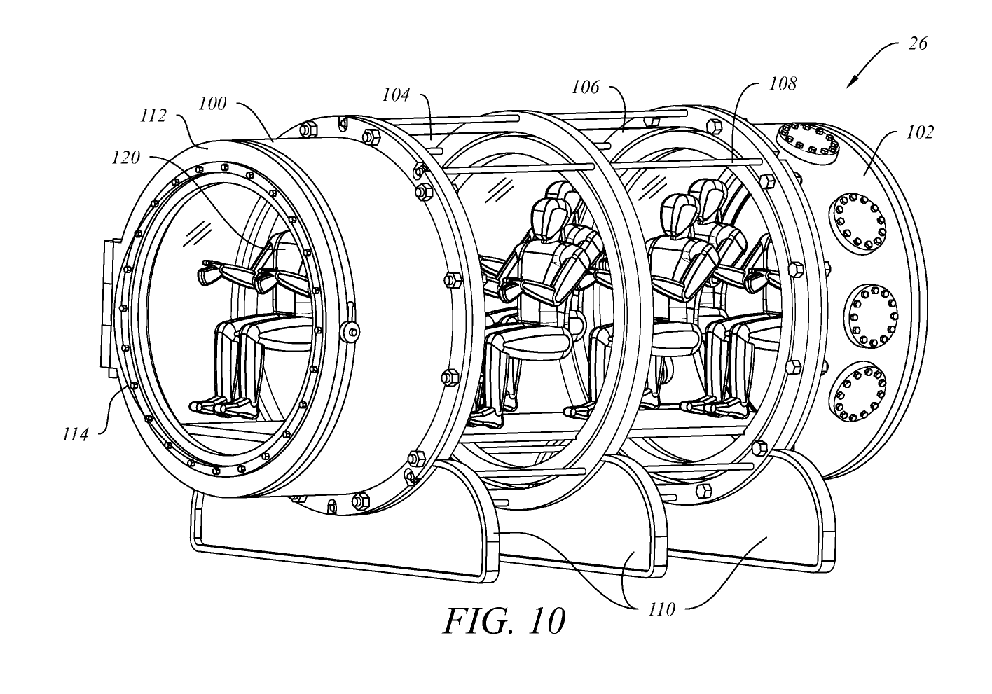

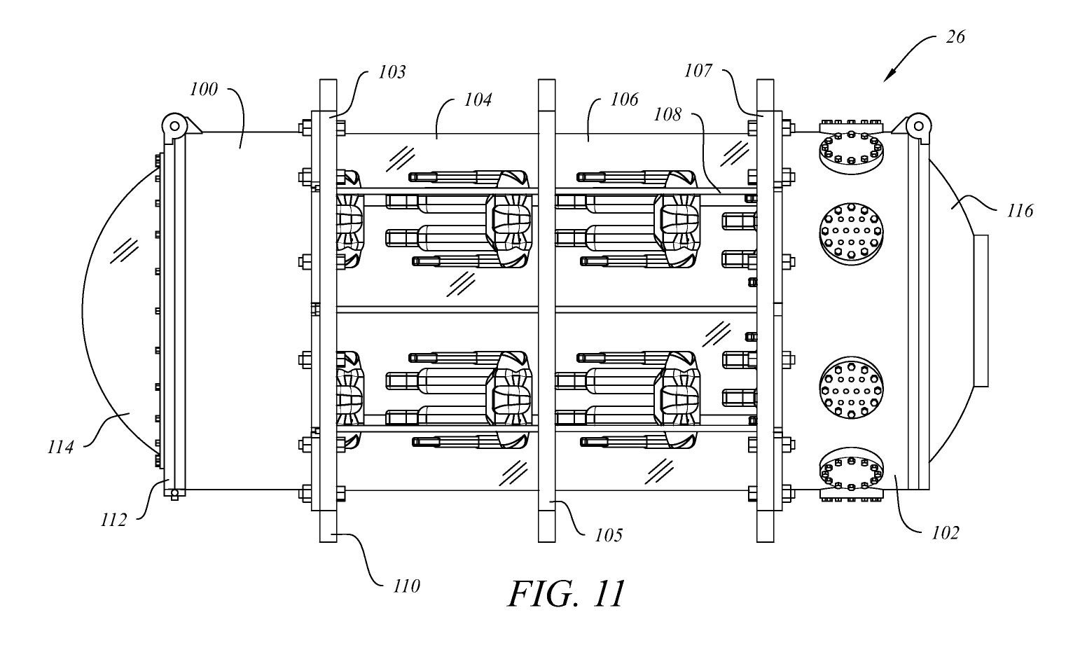

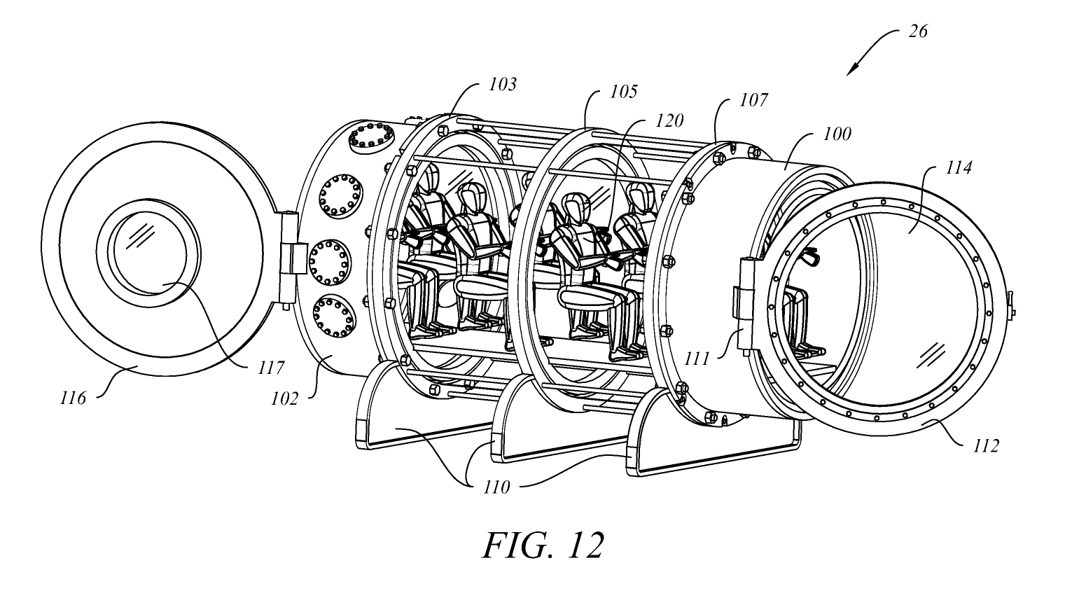

Referring to FIGS. 10-12, Cabin Chamber 26 is another hypobaric test chamber disposed inside facility 38 (FIG. 1). In a preferred embodiment, Cabin Chamber 26 further comprises front and rear cylindrical body sections 100, 102, respectively, spaced apart by transparent annular sidewall sections 104, 106. The body sections and sidewall sections are held together by annular frame members 103, 105, 107 and by a plurality of circumferentially spaced, longitudinally extending connector rods 108. Each of annular frame members 103, 105, 107 is supported by a component member of stand 110. As with Suit Chamber 24, a front door 112 is provided that comprises a hemispherical, transparent observation dome 114 surrounded by annular frame member 112 supported by hinge 111. Similarly, a hinged rear door 116 is desirably provided that further comprises a smaller-diameter viewing port 117. According to this embodiment of the invention, additional circumferentially spaced viewing ports and/or air inlet and outlet ports are also optionally disposed around the perimeter of rear body section 102. As depicted in the embodiment shown in FIGS. 10-12, Cabin Chamber 26 is configured to be used by up to eight occupants 120 wearing pressurized suits.

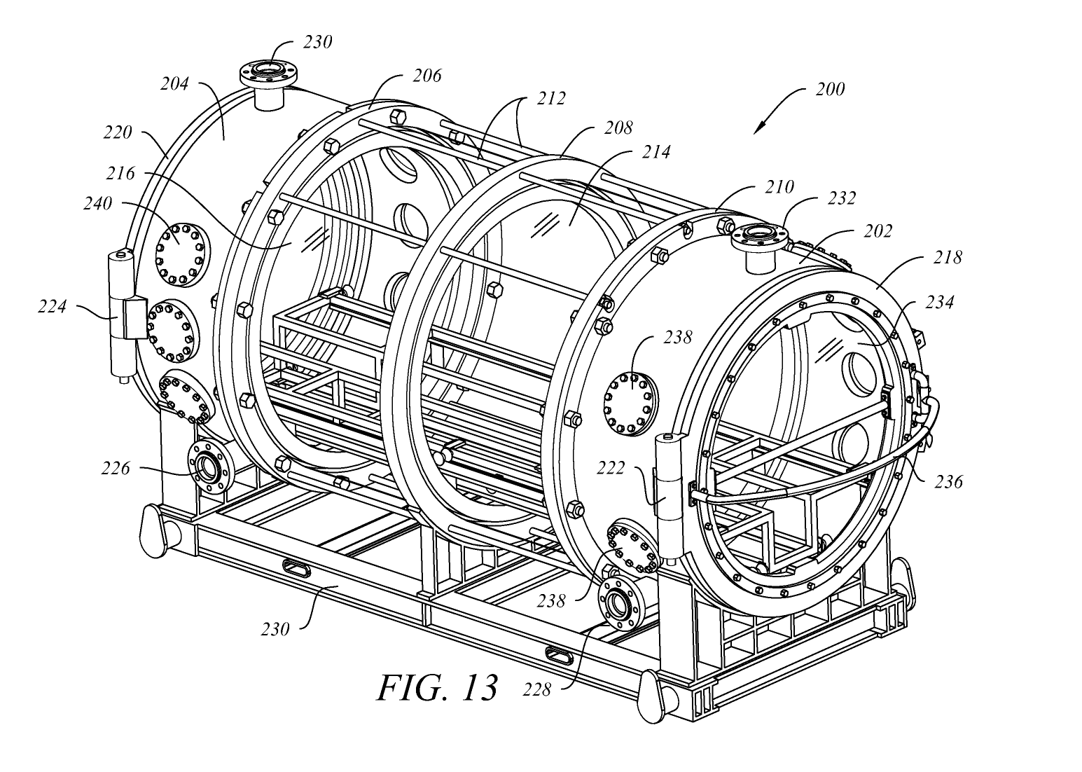

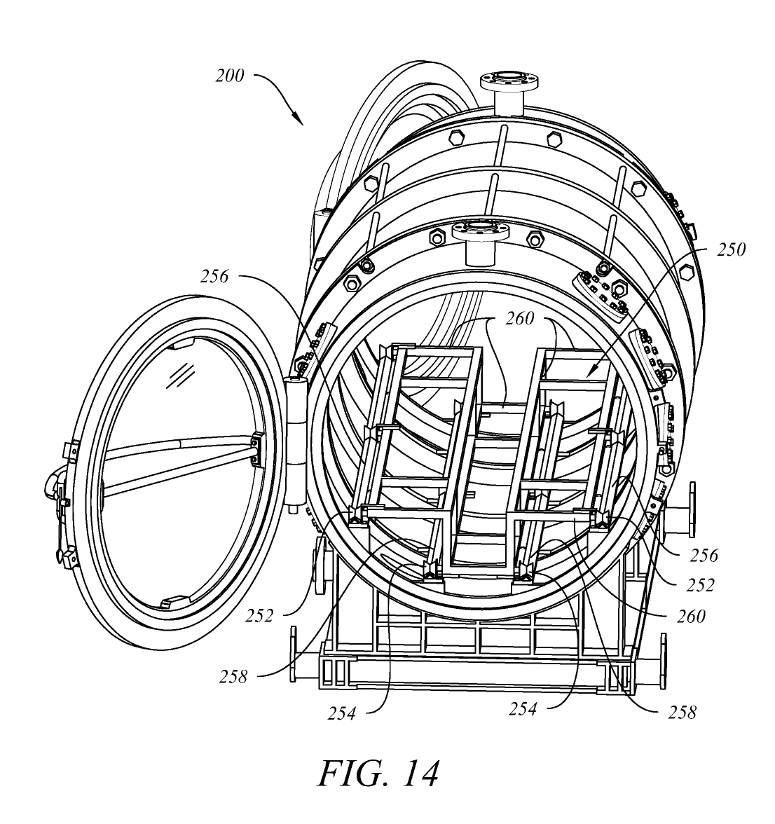

Referring to FIGS. 13-15, Cabin Chamber 200 is disclosed that is constructed similarly to Cabin Chamber 26, but also differs in several significant respects. As with Cabin Chamber 26, Cabin Chamber 200 desirably comprises a basic design having front and rear cylindrical body sections 202, 204, respectively, that are separated by two transparent cylindrical sidewall sections 214, 216 supported by annular frame members 206, 208, 210 and held in place by a plurality of circumferentially spaced, longitudinally extending connector rods 212. As with Cabin Chamber 26, a front door 218 is provided that comprises a substantially hemispherical, transparent observation dome 234 surrounded by annular frame member supported by hinge 222. Handle 236 is provided for assistance in opening front door 218. Similarly, a hinged rear door 220 is desirably provided that further comprises a smaller-diameter viewing port (barely visible through transparent sidewall section 216). In this embodiment of the invention, front cylindrical body section 202 and rear cylindrical body section are provided with air inlet and outlet conduits 226, 228, 230, 232 and viewing ports 238, 220. Unlike Cabin Chamber 26, Cabin Chamber 200 is supported by a cradle 230 comprising a plurality of longitudinally extending rails and cross-members, and is also configured to receive a rail and carriage system 250 (FIG. 14) inside the chamber.

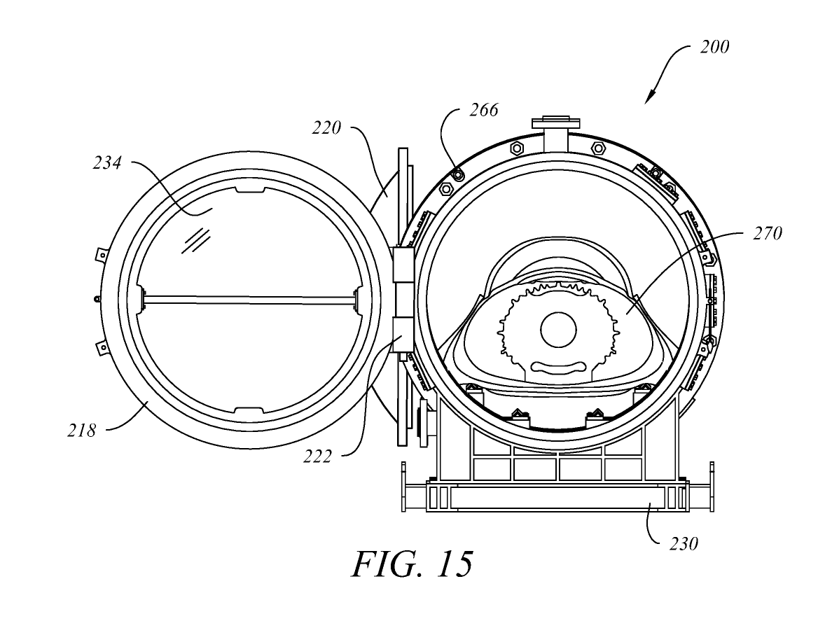

Referring to FIG. 14, an interior view, partially broken away, of Cabin Chamber 200 is provided in which both the front and rear doors are open and a carriage 260 is supported on interior rails 256, 258 that are supported by structural members of cradle 230 disposed externally to the open chamber. Carriage 260 is desirably configured to move into and out of Cabin Chamber 200 by rollers 252, 254 riding on longitudinally extending interior rails 256, 258. With this configuration, large or heavy payloads can be moved into and out of Cabin Chamber 200 with minimal effort. This utility is demonstrated, for example, in FIG. 15, which depicts a mock-up of a space capsule 270 disposed inside a chamber as previously described in relation to FIGS. 13-14.

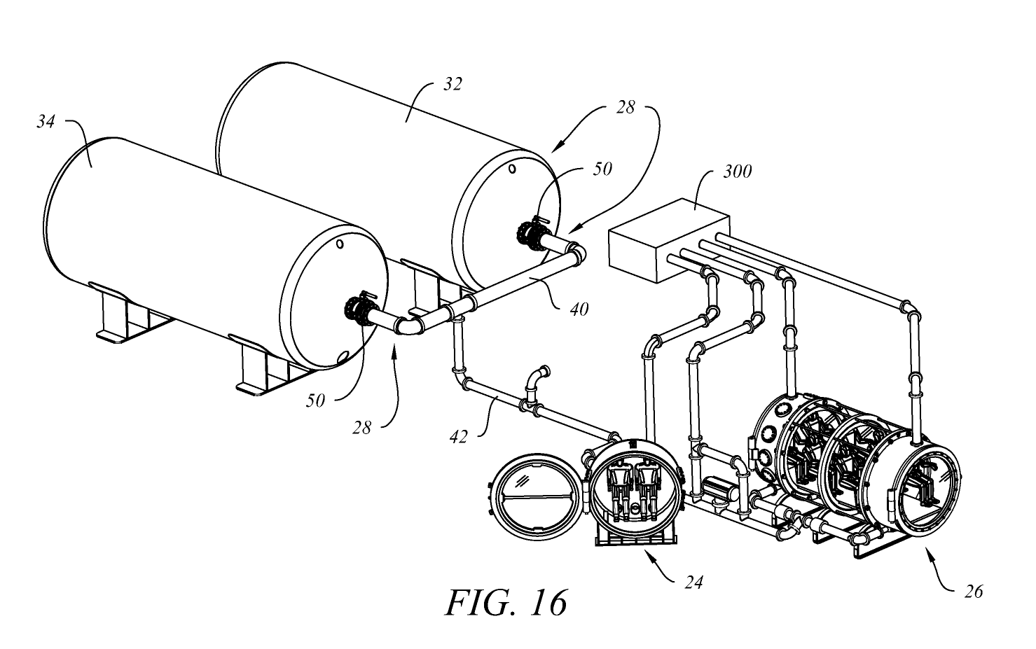

Referring to FIG. 16, apparatus 300 is an optional vacuum pump adapted to make finer adjustments to the air pressure inside hypobaric test chambers 24, 26 than are achievable using only vacuum tanks 32, 34, valves 50 and the associated flow lines 40, 42 of vacuum system 28.

One satisfactory embodiment of the system of the invention desirably comprises a plurality of hypobaric test chambers of different sizes that are operatively couple to a depressurization or decompression apparatus desirably further comprising a vacuum system comprising at least one vacuum tank and preferably including at least two vacuum tanks having a combined volume at least greater than the volume of each of the plurality of hypobaric test chambers. The vacuum system is desirably provided with a vacuum pump for use in evacuating the vacuum tank(s) in advance of depressurizing the test chamber(s), thereby providing capacity for rapidly depressurizing the test chambers, and for use in maintaining fine altitude control and adaptability for use with various pressure suit and chamber configurations.

All systems are desirably compliant with ASME Safety Standard for Pressure Vessels for Human Occupancy (ASME PVHO-1-2012); ASME Boiler and Pressure Vessel Code, Sec. VIII Div. 1 (2013) Rules for Construction of Pressure Vessels; and ASME Code for Pressure Piping, B31 (ASME B31.3-2012).

The test chambers of the subject hypobaric system and apparatus are desirably housed inside a facility having a control room with a viewing area, and all test chambers are provide with large, clear acrylic viewing ports that allow full visibility of all chamber occupants and equipment. The hypobaric test chambers are each desirably configured to accommodate and support various test parameters and objectives.

More particular specifications for a representative embodiment of the plurality of differently sized hypobaric test chambers including at least one each of an Equipment Chamber, Suit Chamber and Cabin Chamber are set forth in the Examples below. The chambers are desirably constructed primarily of steel and clear acrylic polymer to provide full visibility of suited personnel from outside the chamber. The chambers desirably have an operational life of about 20 years, and comprise reconfigurable interfaces to accommodate different needs and uses. The pressure ratings should accommodate storage temperatures ranging from about −12° F. to about 116° F. and an operating temperature range of from about 50° F. to about 95° F.

### Example 1

A representative embodiment of the Equipment Chamber of the invention has a capacity to contain articles having dimensions such as, for illustrative purposes, about two feet by two feet by 1.5 feet. The chamber can simulate altitude environments up to 100,000 feet and can maintain altitudes for at least four weeks.

### Example 2

A representative embodiment of the Suit Chamber of the invention desirably has a capacity to contain two persons in pressure suits, and will support defined flight profiles to an altitude equivalent of 100,000 feet. Depressurization from sea level to about 100,000 feet is desirably achieved within from about 5 to 15 seconds. A two-person Suit Chamber is desirably at least about six feet in diameter and weighs approximately 6500 pounds. A preferred application for the Suit Chamber is testing pressurized flight suits.

### Example 3

A representative embodiment of the Cabin Chamber of the invention has a capacity of up to ten persons in pressure suits and supports defined flight profiles to altitudes of 100,000 feet and rapid decompression to 60,000 feet. The Cabin Chamber is also desirably equipped with reconfigurable interfaces to accommodate various pressure suit and chamber reconfigurations. According to one preferred embodiment of the invention, a Cabin Chamber is disclosed that is 17 feet long, 8 feet in diameter, and weighs more than 25,000 pounds. The Cabin Chamber comprises wall segments made of 2-inch thick acrylic and can hold two standing adult occupants and eight sitting adult occupants. An 8-inch diameter pipe is desirably provided for use in rapidly evacuating the chamber.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventors and Applicant are legally entitled.

What is claimed is:

1. A ground-based hypobaric testing system comprising a plurality of hypobaric test chambers, each further comprising a contained volume of air at ambient atmospheric pressure, in combination with apparatus configured to depressurize at least one of said hypobaric test chambers to an internal pressure level equivalent to atmospheric pressures at an altitude ranging between about 60,000 and about 100,000 feet above sea level within an interval of about 5 to about 15 seconds, and to sustain such internal pressure level throughout a predetermined operational period.

2. The ground-based hypobaric testing system of claim 1 wherein each of the plurality of hypobaric test chambers is differently sized and configured.

3. The ground-based hypobaric testing system of claim 1 wherein the desired operational period ranges from minutes to weeks.

4. The ground-based hypobaric testing system of claim 1 wherein each hypobaric test chamber further comprises at least one viewing port providing large-scale interior visibility.

5. The ground-based hypobaric testing system of claim 1 wherein the apparatus comprises at least one vacuum tank operatively connected to at least one hypobaric test chamber for use in selectively depressurizing the at least one hypobaric test chamber.

6. The ground-based hypobaric testing system of claim 5 further comprising at least one other vacuum tank configured for use in selectively adjusting the pressure inside the at least one hypobaric test chamber following depressurization.

7. The ground-based hypobaric testing system of claim 1 comprising at least one equipment chamber, at least one suit chamber and at least one cabin chamber.

8. The ground-based hypobaric testing system of claim 1 wherein at least one hypobaric test chamber comprises a hoist system.

9. The ground-based hypobaric testing system and apparatus of claim 1, further comprising a rail and carriage system useful for supporting and selectively transporting objects or personnel into and out of at least one of the hypobaric test chambers.

10. The ground-based hypobaric testing system and apparatus of claim 4 wherein each hypobaric test chamber has an interior diameter and at least one substantially clear, substantially full-diameter viewing port providing clear interior visibility to an external observer.
